(19) United States
(12) Patent Application Publication
(10) Pub. No.: US 2010/0147460 A1
(43) Pub. Date: Jun. 17, 2010

(54) PROCESS FOR MANUFACTURING A COMPLEX PIECE MADE OF COMPOSITE MATERIAL WITH LONG FIBERS AND THERMOSETTING MATRIX

(75) Inventor: Patrice Lefebure, Malakoff (FR)

Correspondence Address: RATNERPRESTIA, P.O. BOX 980, VALLEY FORGE, PA, 19482, US

(73) Assignee: European Aeronautic Defence and Space Company EADS France, Paris (FR)

(21) Appl. No.: 12/519,078

(22) PCT Filed: Dec. 10, 2007
(86) PCT No.: PCT/EP07/63611

§ 371 Date: Jan. 20, 2010

(30) Foreign Application Priority Data
Dec. 13, 2006 (FR) 06 55461

(51) Int. Cl. B32B 37/14

(52) U.S. Cl. 156/307.1

(57) ABSTRACT

To manufacture a piece made of composite material with thermosetting matrix, at least one element of the piece is manufactured separately based on strips of fibers preimpregnated with thermosetting resin, which element is subject to a partial thermal curing, having the effect of partially polymerizing the resin of the first element, on the one hand, up to a stage in which the first element has acquired both a sufficient chemical stability to guarantee its storage at ambient temperature and a sufficient dimensional stability to ensure its handling and to guarantee its integrity during later manufacturing operations of the piece and, on the other hand, limited to a stage in which the material forming first element has thermoplastic properties making possible a plastic forming of the first element by raising its temperature at least locally.

### CROSS REFERENCE TO RELATED APPLICATIONS

This application is the U.S. national phase application of PCT International Application No. PCT/EP2007/063611, filed Dec. 10, 2007, which claims priority of French Patent Application No. FR 2006/55461, filed Dec. 13, 2006, the contents of such applications being incorporated by reference herein in their entireties and for all purposes.

### FIELD OF THE INVENTION

The present invention belongs to the field of manufacturing pieces made at least partly with a composite material comprising long fibers in an organic thermosetting matrix. The present invention pertains to a manufacturing process particularly suitable for the manufacture of a more or less complex piece capable of being manufactured from a plurality of elements comprising the piece after assembly.

### BACKGROUND OF THE INVENTION

Composite materials are now widely used for the manufacture of pieces in many fields of industry, including for structural pieces, i.e., having to support significant strains during their use.

There are many composite materials, the most widely used being made of more or less long fibers of inorganic or organic (glass, carbon, aramide, . . . ) materials contained in a matrix formed by a hard organic resin.

Among the many composite materials used and the many associated working processes, one of the categories, most widely used particularly because of its reasonable cost, is associated with preimpregnated thermosetting materials.

In this category of pieces made of composite materials, strips of long fibers preimpregnated with resin, before entering into the manufacture of a piece, are processed in a first time, i.e., cut and shaped, for example, using a recessed or raised mold. The resin which impregnates the fibers is not polymerized at a significant stage and generally has a pastiness at this stage. Therefore, the strips of preimpregnated long fibers, e.g., in sheets or woven form, do not have a rigidity that enables them to conform closest to the shapes of the molds.

When all the parts of the piece have been arranged in this manner, the piece is subject to a curing operation, a thermal curing according to a cycle suitable for the resin used, which has the effect of irreversibly setting the resin by polymerization. This thermal curing is generally performed by applying pressure on the piece at certain steps of the said curing in order to drain the supernatant resin by flow before its setting to obtain an as high as possible fiber content in the finished material forming the piece and also to eliminate traces of porosity as much as possible.

Most often the materials used are delivered to workshops beforehand to ensure their already preimpregnated shaping, the preimpregnation being itself a complicated and specialized operation, and are stored at low temperatures to prevent them from setting at ambient temperature before their use.

When a complex piece has to be made of a composite material, the operations consisting of depositing preimpregnated fibers may be delicate to carry out, particularly whenever the quality and reproducibility of the results are essential.

Complex piece must be defined as a piece comprising zones whose shapes make depositing preimpregnated long fibers on the corresponding mold difficult or even impossible. This may be the case, for example, of a stiffened panel such as the one shown in FIG. 1a comprising a skin 2 of constant or variable thickness and stiffening elements 3 on one or both faces of said skin. The stiffeners may have varied shapes, for example, said Ω-, Z, U or L shapes as illustrated in FIG. 1c, some of which are difficult to extract from the mold after the setting, for example, stiffeners having a Z-shaped cross section, and even impossible to extract from the mold by conventional methods, such as the Ω-shaped stiffeners of FIG. 1a or FIG. 1b.

When manufacturing of the piece in a single step has been abandoned industrially, the most widely used solution consists of determining different subsets in the complex piece as illustrated in FIG. 1b, each forming an element which shall be made individually with the composite material, and then of assembling the different already set elements by gluing or by other prior-art methods of assembly.

Thus, in the example shown in FIGS. 1a and 1b, the stiffeners 3 are made of materials that are set on specialized molds, the skin is made on another mold and then the different set elements are assembled.

This method is widely used, but it has the drawback of assembling the pieces before having been made with dimensional tolerances and tight shapes, as close as possible to those of the final piece, and in addition, it implies a later assembly of the elements, which does not make it possible to obtain the homogeneity obtained when the elements are set in contact with a same polymerization thermal curing.

### SUMMARY OF THE INVENTION

The process according to the present invention avoids most of the drawbacks of the prior-art processes for manufacturing pieces made of composite thermosetting materials without reducing the structural performances obtained for the manufactured piece.

### BRIEF DESCRIPTION OF THE DRAWINGS

FIG. 1 shows, as an example, a stiffened panel representing a complex piece made of composite material, assembled in FIG. 1a and with the different elements separated in FIG. 1b and FIG. 1c shows examples of profiles of stiffeners;

FIG. 2 shows the steps of the process of manufacturing the stiffened panel.

### DETAILED DESCRIPTION OF PREFERRED EMBODIMENTS OF THE INVENTION

The process according to the present invention avoids most of the drawbacks of the prior-art processes for manufacturing pieces made of composite thermosetting materials without reducing the structural performances obtained for the manufactured piece.

For this, a piece made of composite material based on strips of long fibers preimpregnated with at least one thermosetting resin, irreversibly setting during a thermal curing of polymerization and comprising two or more assembled elements, is subject, during the process of manufacturing the said piece, to a thermal curing of setting by polymerization in a known manner. According to the process, at least a first element forming a part of the piece is manufactured, separately from the piece, from a more or less flat plate, the flat plate itself being manufactured by depositing strips of fibers preimpregnated with a thermosetting resin and subject, after the said depositing during a step of the process, to a partial thermal curing, having the effect of partially polymerizing the resin of the said flat plate. This partial polymerization is, on the one hand, led up to a stage in which the first element has acquired a sufficient dimensional stability which makes it possible to handle it and to guarantee its integrity during later operations of manufacturing the piece, and, on the other hand, it is limited to a stage in which the material forming the said first element has rheological properties comparable to those of thermoplastic composite materials making possible a steelwork type plastic forming of the said first element by raising its temperature at least locally so that the shape of the said first element might be modified.

The flat plate is subject to at least one plastic forming step, during a later step of the process, to give a desired shape to the first forming element associated with a raising, at least locally, of the temperature of the material forming the said first element.

The geometric shapes given to the first element manufactured separately are both stable and modifiable, and the resin of said first element is capable of creating new molecular bonds because of its polymerization which has not been brought to maturity. Advantageously, these elements can be stored at ambient temperature in the absence of expensive cooling apparatus.

The first element is shaped during the draping of the strips of long fibers preimpregnated with thermosetting resin or else it is only partially formed and, after having been subject to partial thermal curing, undergoes a plastic forming step associated with a raising, at least locally, of the temperature of the material forming the said first element. Advantageously, when the shape of the first element permits, a more or less flat plate is made of thermosetting composite material, having undergone a partial thermal curing, and then shaped by cutting, folding or forming of the plate using the thermoplastic properties acquired by the said plate.

The said at least one first element, subject to a partial thermal curing, is assembled with at least one second element based on strips of long fibers preimpregnated with a thermosetting resin to form the piece to be manufactured before the full setting of the resin of the second element, and the said first element and the said second element are subject to a joint thermal curing for the complete polymerization of the resins of the said first and second elements so that an interdiffusion of the macromolecular chains of the resins is created at the interface of the elements forming the piece, and so that a final homogeneous degree of curing is obtained in the entire piece.

In a first embodiment, the first elements and the second elements are assembled at a stage in which the preimpregnated fibers used in the second elements are not subject to a thermal setting cycle, which proves to be advantageous when the first element or elements are easy to place on the fibers of the second elements.

In a second, preferred embodiment, when the second elements have to be removed from a mold and/or have to be shaped before placing the first elements, the first elements and the second elements are assembled at a stage in which the preimpregnated fibers used in the second elements have also been subject to a partial thermal curing.

To guarantee the quality of the bonds between the different elements, the thermosetting resin used to impregnate the fibers of the first elements and those used to impregnate the fibers of the second elements are chemically compatible to be capable of creating molecular bonds during the joint thermal curing. Advantageously, the same thermosetting resin is used to impregnate the fibers of the different elements.

According to the process the elements or plates having been subject to partial thermal curing are stored at ambient temperature for later assembly, with or without preliminary thermoforming in order to optimize the production cycles of the pieces.

To obtain pieces with high mechanical resistances, the preimpregnated fibers used for the manufacture of a flat plate for the manufacture of an element (2, 3) comprise fiber contents, i.e., the ratio of fibers only to fibers with preimpregnating resin, equal to or greater than 65% by weight or equal to or greater than 60% by volume.

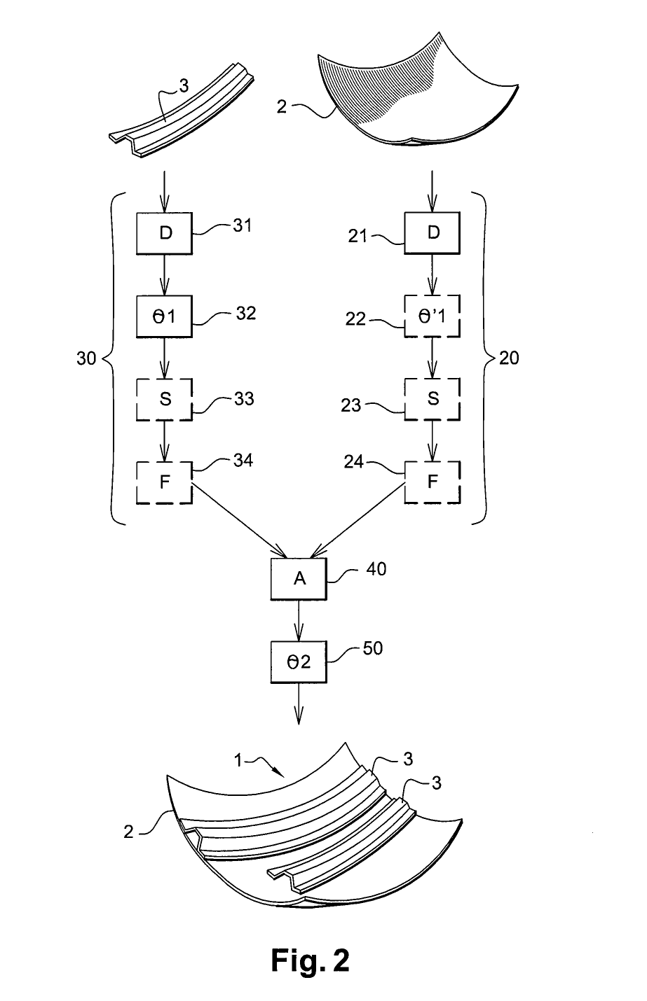

According to the process of the present invention shown in FIG. 2, a complex piece made of composite material is made from strips of long fibers preimpregnated with a thermosetting resin.

Strip is defined as any flat and unidirectional layout of long fibers prepared independently of a piece to be manufactured with a view to facilitating the deposit of the fibers.

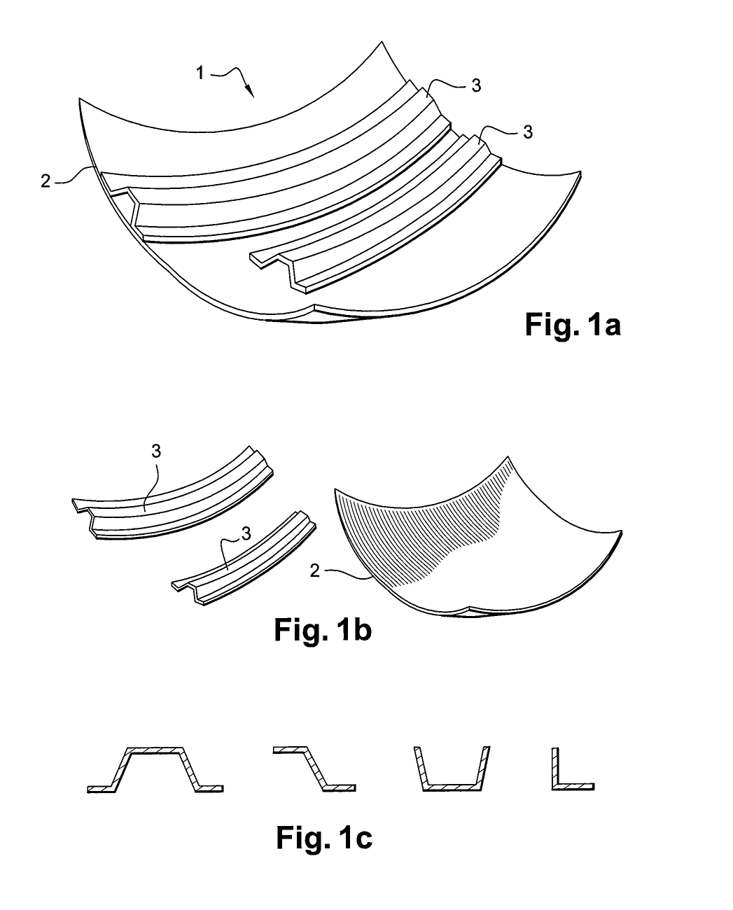

In the following description, the process shall be described in detail for the manufacturing of a stiffened panel 1 of the same type as that shown in FIG. 1 without this example being restrictive.

The stiffened panel shown in FIG. 1a comprises a skin 2, whose thickness may be more or less constant or, as is most frequently the case in structures in which the most reduced mass possible is sought, it may vary according to the considered location of the panel depending on local stresses applied to the said panel. The stiffened panel 1 also comprises at least one stiffener 3, for example, a said Ω-shaped stiffener, whose open part is integral with one of the faces of the skin 2.

In a first step, the complex piece, stiffened panel 1, is broken up into elements or subsets as shown in FIG. 1b, the skin 2, on the one hand, and the at least one stiffener 3, on the other hand, capable of being formed separately and of being assembled to form the desired complex piece.

In a second step 30, at least one of the first elements, for example, the at least one stiffener 3, is made with the thermosetting preimpregnated material chosen for making the piece.

This second step 30 comprises variants, but it is characterized in that it comprises a thermal curing phase 32, said partial thermal curing, which has the effect of partially polymerizing the resin in such a way:
that, at the ambient temperature of a workshop, about 20° C., it gives a proper rigidity to the element manufactured, enabling it to more or less preserve its shape when it is not subject to significant mechanical stresses and to be able to be stored over long periods, in proportion to the time of the industrial manufacturing processes considered, without significant chemical change in the resin;
that a later, temporary raising of the temperature leads to a lowering of the rigidity of the composite material forming the element giving it physical and rheological properties similar to those of a thermoplastic composite material.

The said partial thermal curing phase is, e.g., a thermal curing for setting the thermosetting material usually used to polymerize and set the composite material and which is interrupted before the complete gelling of the resin, i.e., the point in the polymerization process at which the density of the three-dimensional network of molecular chains within the resin has reached a stage for which the said resin no longer has sufficient properties for conventional use of preimpregnated fibers. The moment at which it is desirable to interrupt the thermal curing depends on the type of resin used. It is determined, for example, experimentally, near the gelling point of the said resin.

Hence, the process uses a so-called thermoplasticity property which thermosetting materials, which are usually insensitive to heat after polymerization (within the limits of the chemical stability of the polymerized resin), have temporarily during the usual process of setting by polymerization.

To the knowledge of the inventor, no prior-art process of manufacturing structural pieces made of composite material uses the thermoplastic properties obtained by means of a partial thermal curing for polymerization of a thermosetting material.

In a method of implementing the second step 30 of the process, the preimpregnated material is deposited 31 on a recessed or raised form to give the element a shape close to that which it must have in the complex piece.

For example, the preimpregnated fibers are deposited in a recessed form having the external shape of the stiffener 3. This operation is, for example, carried out by draping manually or by means of a machine for draping sheets of preimpregnated fibers.

In association with pressures that are suitable for the material, the element is subject to the partial thermal curing 32 and it is then removed from the form on which it was formed. It shall be noted that at this stage, after the element returns to ambient temperature, the polymerization of the resin is very slow, and that the element can be stored 33 for at least six months, according to the tests carried out, under ambient conditions when the temperature is kept below 40° C. with a relative humidity lower than 60% without said thermoplastic properties more or less changing.

If necessary, after removing the element from the mold, its thermoplastic properties are used to locally modify its shape. For example, a stiffener 3 is advantageously made in a rectilinear mold and then undergoes a thermoplastic forming 34 intended to give it curves or twists suitable for its destination location on the panel 1. A same mold may thus be used to form stiffeners having more or less the same cross sections but different in their final shapes.

In another preferred method of implementing the second step 30 of the process, more or less flat plates are made 31 with the preimpregnated material and are then subject to the partial thermal curing 32 to obtain plates having thermoplastic properties. These plates, made with the thickness desired for the element, for example, the thickness of the walls of the stiffener, are then cut and then thermoformed 34 to make the element 3.

The advantage of manufacturing flat plates is due, on the one hand, to the simplicity of manufacturing such plates, which do not require using molds of complex shapes and also complex machines, for example, machines with multiaxial heads for the placing of strips of preimpregnated fibers, and, on the other hand, to the possibility both due to the selection of the materials used and due to the process of manufacturing the plates, making it possible to use high and uniform pressures to obtain fiber contents, ratio of fiber weight or volume of the material obtained to its total weight or its total volume resulting from the fibers and from the impregnating resin, equal to or greater than 65% by weight or equal to or greater than 60% by volume.

The preimpregnated fibers used preferably themselves comprise fiber contents equal to or greater than 65% by weight or to 60% by volume to manufacture the flat plates.

The thermoforming is carried out according to such conventional methods as, for example, folding or forming between a form and a counterform. The advantage of this solution is that it is easy and less expensive to produce flat plates, which can be produced in series and stored without difficulty at ambient temperature awaiting their use, and that various thermoforming techniques are known and mastered.

In a third step 20 of the process, a second element of the piece, for example, the skin 2 of the panel 1, is prepared according to a conventional method by depositing 21, for example, by draping sheets of fibers, fibers impregnated with a thermosetting material on a form or into a mold.

It shall be remarked that the order of execution of the steps 30 and 20 of the process is not imposed and results from an industrial selection corresponding to the order of preparation of the elements 2, 3. In particular, the said steps may be simultaneous or even overlapped over time.

In a fourth, so-called assembly step 40 of the process, the at least one first element, e.g., a stiffener 3, produced during the second step of the process, and if necessary, other elements, such as other stiffeners prepared according to the cycle of the second step 30 of the process, is positioned against the thermosetting material of the second element prepared during the third step, the skin 2, depending on the location that the said at least one first element, the stiffener 3, has to have in the piece to be manufactured, the stiffened panel 1.

The placing of the said at least one first element, the stiffener 3, proves to be much easier than in the prior-art methods.

On the one hand, said element has a certain rigidity at ambient temperature and a stability that enables it to be handled without particular means, such as molds or mold cores carrying non-set preimpregnated fibers necessary in the prior-art processes.

On the other hand, the said element remains sufficiently less rigid to be easily formed to the desired shape during its positioning and maintained at the desired location against the other element, contrary to the processes which assemble fully polymerized elements which are too rigid to be more or less deformed.

In a fifth step 50 of the process, the assembled elements are subject to a complete thermal curing which has the effect of bringing about the complete polymerization of the resin of the preimpregnated fibers used during the third step 20 of the process, the material of the skin 2, and of terminating the polymerization of the resin of the preimpregnated fibers used during the second step 30 and having undergone a partial thermal curing, the material of the stiffener 3.

Complete polymerization should be defined as the level of polymerization of the resins used that is attained in the conventional processes when it is considered that the composite material has acquired stable mechanical properties accepted as final.

During this step 50, the molecular chains of the resin of the at least one first element, of the stiffener 3, having undergone a partial thermal curing, are again in a position to create bonds with the resin of the second element, of the skin 2, not having undergone this partial curing when the resins used are chemically compatible, which enables the elements of the piece, the skin 2 and the stiffener 3, to join together, because of the long molecular chains that interdiffuse in the matter of the two assembled elements, with performances equivalent to those obtained by prior-art processes of simultaneous curing of elements not having undergone partial thermal curing.

The thermosetting resins of preimpregnated fibers used for the different elements making up the piece are preferably resins having a good molecular affinity. In a particular embodiment, the resins of the different elements, skin 2 and stiffener 3, are the same.

In a variant of the process, shown by optional steps framed by broken lines in the diagram of FIG. 2, the different elements, skin 2 and stiffener 3, before forming the piece, are manufactured by applying the second step of the process, the second element, the skin 2, hence being itself subject to a partial thermal curing as well. In this variant, the third step 20 of the process described above is hence replaced with a step equivalent to the second step 30, comprising, in an equivalent manner, steps of depositing preimpregnated fibers 21, partial thermal curing 22, storage 23, if necessary, and forming 24, if necessary.

In this case, the thermal curing of the fifth step 50 can be adapted to take into account the fact that all the elements of the piece have already been subject to a partial thermal curing 32, 22.

The process according to the present invention thus makes it possible to manufacture a piece made of composite material based on fibers preimpregnated with thermosetting resin, simplifying the operations of handling the elements forming the piece and with simplified equipment as well.

1.-8. (canceled)

9. A process for manufacturing a structural piece made of composite material based on strips of long fibers preimpregnated with at least one thermosetting resin, resin which is capable of polymerizing and setting irreversibly during a thermal curing, subject during the process of manufacturing said piece to a thermal curing of setting by polymerization, characterized in that at least a first element forming a part of the piece is manufactured separately from the piece starting from a more or less flat plate, the said flat plate being manufactured by deposition of strips of fibers preimpregnated with a thermosetting resin, subject, after said deposition during a step of the process, to a partial thermal curing, having the effect of partially polymerizing the resin of the said first element, on the one hand, up to a stage in which the first element has acquired a sufficient dimensional stability to ensure its handling and to guarantee its integrity during the later manufacturing operations of the piece and, on the other hand, limited to a stage in which the material forming the said first element has thermoplastic properties making possible a plastic forming of the said first element by raising its temperature at least locally, the said flat plate being subject, during a later step of the process, to give a desired shape to the said first element, to at least one step of plastic forming associated with a raising, at least locally, of the temperature of the material forming the said first element.

10. The process in accordance with claim 9, in which at least a second element of the piece is manufactured by means of strips of fibers preimpregnated with a thermosetting resin and in which the first element having been subject to a partial thermal curing, is assembled with the said second element before complete setting of the resin of the said second element, and before subjecting the said first element and the said second element to a joint thermal curing for complete polymerization of the resins of said first and second elements.

11. The process in accordance with claim 10, in which the first element and the second element are assembled at a step of the process in which the preimpregnated fibers used in the second element have not been subject to a thermal setting cycle.

12. The process in accordance with claim 10, in which the first element and the second element are assembled at a step of the process in which the preimpregnated fibers used in the second element have been subject to a partial thermal curing, having the effect of partially polymerizing the resin up to a stage in which the second element acquires sufficient dimensional stability to ensure its handling and to guarantee its integrity during the later manufacturing operations of the piece and limited to a stage in which the material forming said second element has thermoplastic properties making possible a plastic forming of the said second element by raising its temperature at least locally.

13. The process in accordance with claim 10, in which the thermosetting resin used to impregnate the fibers of the first element and the thermosetting resin used to impregnate the fibers of the second element are chemically compatible to be capable of creating molecular bonds during the joint thermal curing.

14. The process in accordance with claim 13, in which the thermosetting resin used to impregnate the fibers of the first element is the same as the thermosetting resin used to impregnate the fibers of the second element.

15. The process in accordance with claim 9, in which one or more elements and/or one or more plates, having been subject to a partial thermal curing are stored at ambient temperature with a view to a later assembly, with or without preliminary thermoforming.

16. The process in accordance with claim 9, in which the preimpregnated fibers used for the manufacture of a flat plate for the manufacture of an element comprises a fiber content, which is a ratio of fibers alone to fibers with preimpregnating resin by weight or by volume equal to or greater than 65% by weight or equal to or greater than 60% by volume.
